(19) United States
(12) Patent Application Publication
(10) Pub. No.: US 2002/0096240 A1
(43) Pub. Date: Jul. 25, 2002

(54) Automated label application system

(75) Inventors: Barry Eugene Anderson, Westminster, CO (US); John Edward Bordwell, Broomfield, CO (US); Darin Duran, Broomfield, CO (US); Leopold G. Tomajko, Evergreen, CO (US); Todd Mumaw, Englewood, CO (US)

Correspondence Address: PATTON BOGGS, PO BOX 270930, LOUISVILLE, CO, 80027, US

(73) Assignee: Engineered Data Products, Inc.

(21) Appl. No.: 09/954,999

(22) Filed: Sep. 17, 2001

Related U.S. Application Data
(60) Provisional application No. 60/235,230, filed on Sep. 25, 2000.

(51) Int. Cl. B32B 31/00

(52) U.S. Cl. 156/64; 156/361; 156/363; 156/542

(57) ABSTRACT

A label application system that automates a label application process to automatically feed, peel and apply labels to a number of different styles of articles. The label stock is advanced to an application position where the leading edge is deflected over edge guide to peel an individual label approximately half way off of the backing sheet. The article is inserted into the article receiving slot until the lead edge of the article engages a switch and initiates the application of the individual label. An application bar rotates about a horizontal axis swiping the peeled half of the label onto the inserted portion of the article. Substantially, simultaneously the feed operation is initiated to advance the label backing, moving the next sequential label into the application position. The article is then removed from the slot and inserted into a tabbing assembly.

### FIELD OF THE INVENTION

The present invention relates to the field of label application, and more particularly to an automated label application system for generating and uniformly applying a series of labels to various types of articles.

### PROBLEM

It is a problem in the art of labels to apply a series of labels to file folders such that the labeled file folder may be stored with its label readily visible. Labeled file folders are typically stored in filing cabinets and on filing shelves with the labeled ends being adjacent each other along a row of folders such that the labels are readily visible. To easily locate a desired file folder, both the appearance of the labels themselves and the positioning of the labels on the file folders must be uniform. This allows a specific file folder to be easily located by the indicia contained on the label. The misapplication of a label disrupts the uniform appearance making the label difficult to view and the presentation of files sloppy.

Labels are applied to file folders by manually removing a single label from a label backing and applying the label to either a tabbed portion of the file folder, or where no tab is provided, onto one of the folder edges. Where labels containing duplicate information are utilized, only the first half of the label is applied to the tab or folder edge, with the second half being folded over the tab or folder edge so that duplicate label faces may be viewed from either side.

Unfortunately, because these labels are applied manually, typically by a secretary or other office personal, a number of problems can arise during the application process. One common misapplication occurs when the first edge of the label is not applied evenly at the same horizontal depth along the folder tab or folder edge. This results in an uneven crease that partially conceals one of the label sides when the second edge of the label is folded over the tab. Another common misapplication occurs when the second edge of the label is not folded evenly over the folder edge or file folder tab, resulting in creases and/or air pockets being formed in the label face making it difficult to view.

Yet, another problem associated with label application occurs when a label containing a sequential numbering or color scheme is applied in a non-sequential order. The sequential numbers or colors contained on labels are not repeated on subsequent labels. Thus, if a label is removed from the label stock and applied to a file folder in a non-sequential order, the label must be removed and a new label applied. The removal of the label usually results in its destruction requiring a special order of a single label from the label manufacturer to replace the destroyed label. This results in a wasting of material, time, and a corresponding cost burden on consumers.

Therefore, there exists a need in the art to provide an automated label application system that accommodates the application of various label stock to a number of folder styles.

### SOLUTION

The above-described problems are solved and a technical advance achieved by the present automated label application system. The present label application system automates the label application process to automatically feed, peel and apply labels to a number of different styles of articles. Using the principles of the invention, the label application system in conjunction with an operator provides an efficient and accurate method of attaching labels to various articles including but not limited to file folders. In some examples of the invention, the label application system comprises a label application machine configured to receive label stock and automatically apply individual labels from the label stock to the different articles. In other examples of the present invention, the label application system comprises the label application machine connected to a computer system for label generation and a printing system for producing the label stock. The label application machine may be utilized individually or as a system with the computer system and printing system. The label application machine accommodates multiple pieces or sheets of label stock of various sizes and containing various amounts of individual labels. The label application machine also accommodates rolled label stock of various sizes and containing various amounts of individual labels.

### BRIEF DESCRIPTION OF THE DRAWINGS

FIG. 1 illustrates an example of a label application system according to the present invention;

FIG. 2 illustrates another example of a label application system according to the present invention;

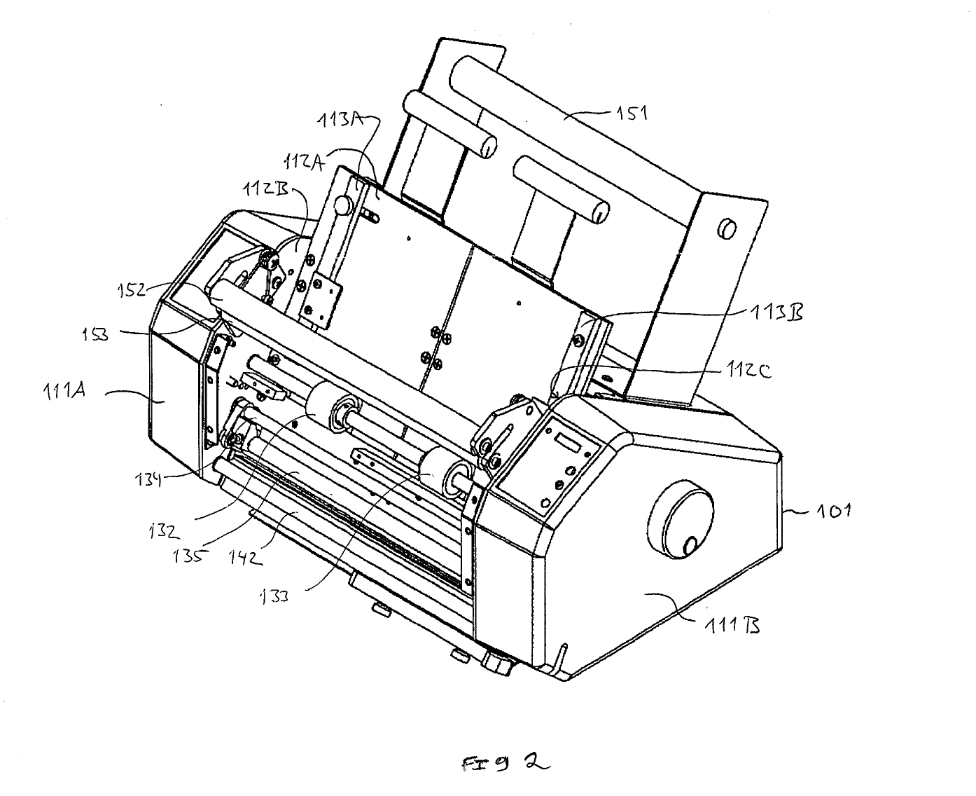

FIG. 3 illustrates a front view of an example of a label application machine according to the present invention;

FIG. 4 illustrates a top view of an example of a label application machine according to the present invention with the covers removed;

FIG. 5 illustrates a right side view of an example of a label application machine according to the present invention with the covers removed;

FIG. 6 illustrates a left side view of an example of a label application machine according to the present invention with the covers removed; and

FIG. 7 illustrates a cross sectional view of an example of a label application machine according to the present invention.

### DETAILED DESCRIPTION

The invention summarized above and defined by the enumerated claims may be better understood by referring to the following detailed description, which should be read in conjunction with the accompanying drawings. This detailed description of the preferred embodiment is not intended to limit the enumerated claims, but to serve as a particular example thereof. In addition, the phraseology and terminology employed herein is for the purpose of description, and not of limitation.

The label application system of the present invention applies labels to file folders and other articles. The label application system can be utilized individually with label stock ordered from a label manufacturer or in combination with a computer system and printing system for both the production and application of labels. Advantageously, the label application machine is designed to be portable, with a compact size and weight of approximately 12 pounds making it easy to move from one work area to another to accommodate various labeling needs. In addition, the label application system provides a mounting assembly for easy attachment and detachment to a workstation.

A preferred feature of the label application system is its ability to accommodate both sheet and rolled label stock. By way of background, labels are typically produced on a detachable label backing. The label backing may be in the form of individual sheets that contain a plurality of individual labels, or may be a continuous sheet of rolled backing that contains a plurality of individual labels. The label application machine accommodates both sheet and rolled label stock using a detachable backing assembly for accommodating sheet stock and a detachable roller assembly for accommodating rolled stock.

Another preferred feature of the label application system is the accommodation of multiple configurations of file folders including but not limited to, tabbed folders, un-tabbed folders, accordion style folders, and multi-sided folders. File folders are typically comprised of at least two flaps folded about a centerline. One of the flaps may or may not include a tab for applying a label thereto. Still other folder styles include two flaps connected by a bottom and accordion style folded sides. Accordion style folders are particularly difficult to accommodate for label application as the accordion sides prevent the folder from lying perfectly flat.

When sheet label stock is utilized, multiple sheets of label stock are manually loaded into a receiving slot that provides adjustable guides for accommodating various sized sheets. In the context of the present invention this is defined as the load position. Once loaded, the sheets are automatically separated and fed individually into the label application machine by a load and feed operation that is initiated through use of control panel by an operator. The load and feed operation is actually two separate functions performed by the label application machine. The load operation loads the lead edge of the first sheet of label stock from the load position to an application position with a separate function performed during the feeding of the label stock to peel an individual label for application to a file folder or other article. The feed operation advances the sheet of label stock through the label application machine as labels are peeled and applied to the file folder or other article. The articles are inserted into an article-receiving slot located on the top of the machine. The article receiving slot also includes an adjustable assembly for guiding various sized articles or file folders. The application of the label is automatically triggered by the insertion of the article to initiate an application function, which applies the label to the article. Alternatively, the application could be triggered through the control panel or other means such as a foot pedal. The application function includes a rotating application bar that swipes the first half of the label onto the article. The article is then removed from the article-receiving slot and inserted into a tabbing assembly. Advantageously, the tabbing assembly is detachable from the label application machine to provide the flexibility of having multiple operators during large label application jobs. The tabbing assembly operates to automatically fold the second half of the label over the edge of the article producing a finished product. When rolled label stock is utilized, the operation is substantially the same except that a roller assembly for accommodating the roll stock is utilized and the load operation is only performed once to advance the lead edge of the label backing to the application position. While it is operator dependent, testing reveals that on average a single operator utilizing the label application system of the present invention can generate approximately 400-500 labeled file folders per hour, while two operators can produce approximately twice as many labeled file folders.

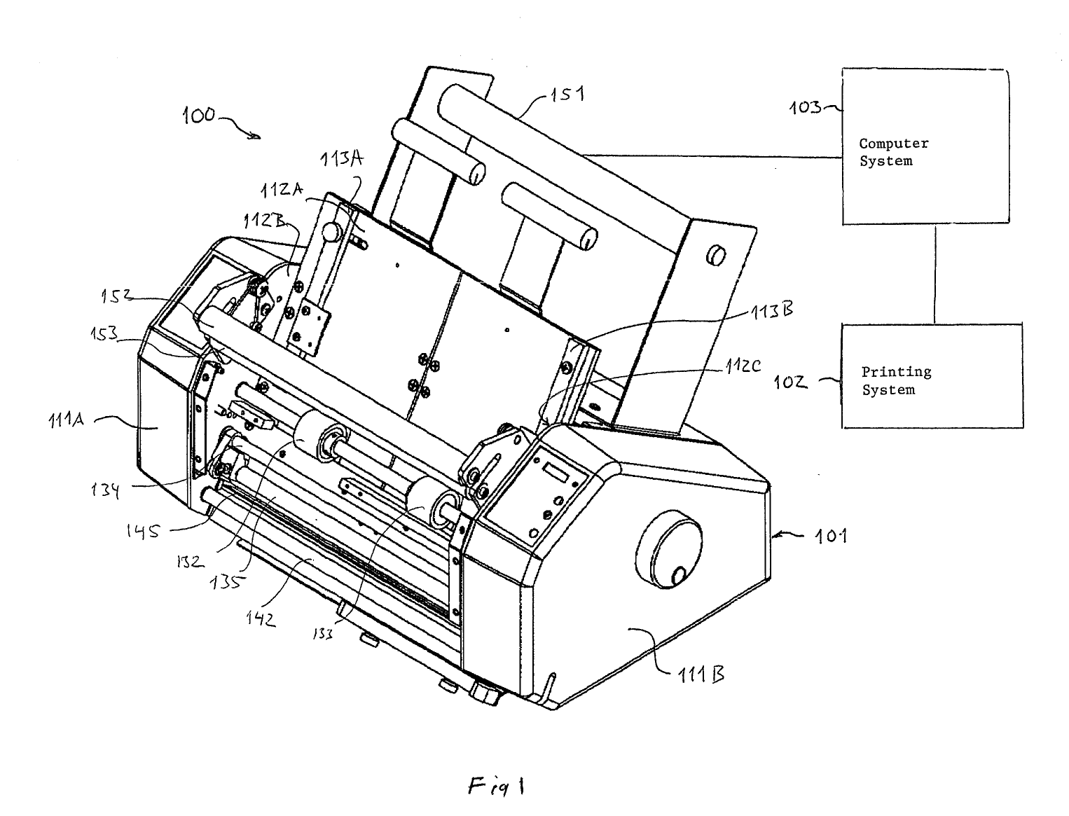

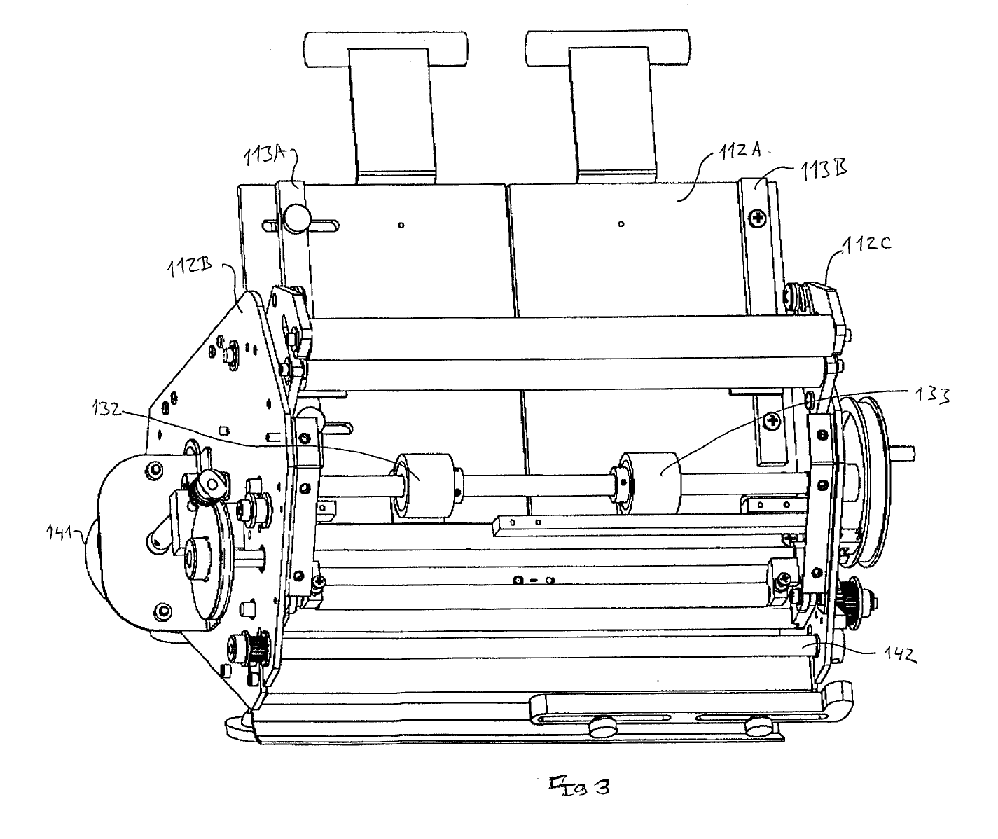

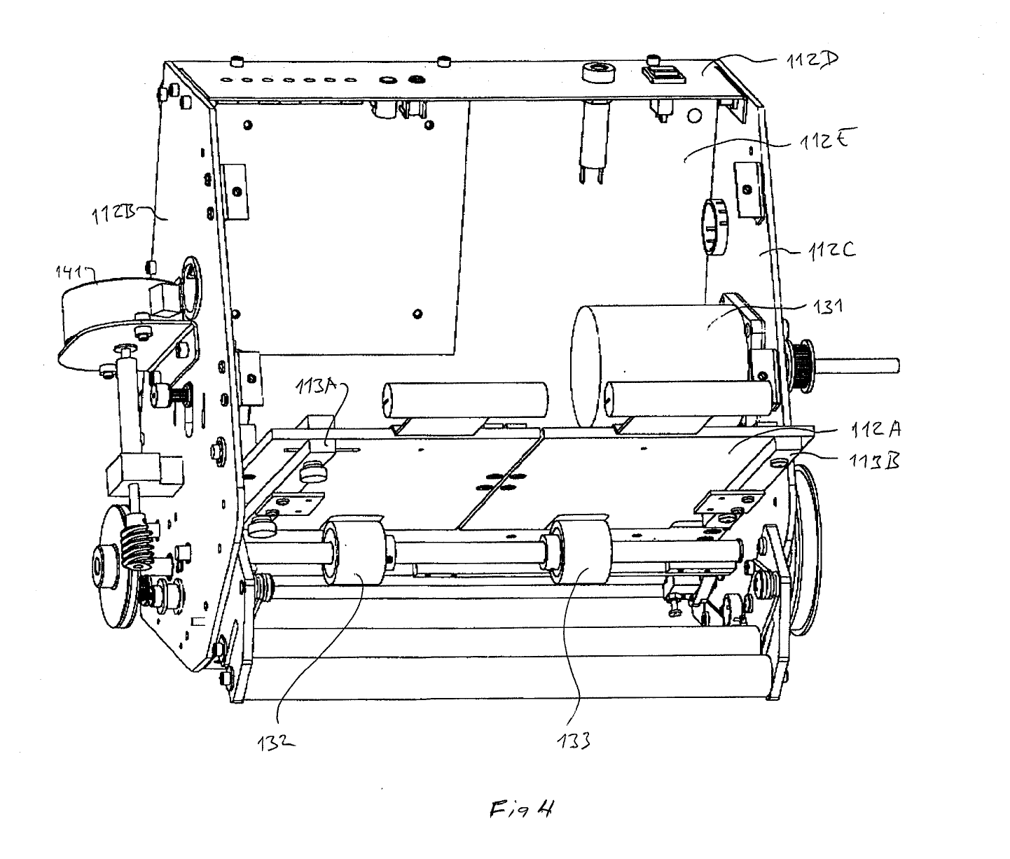

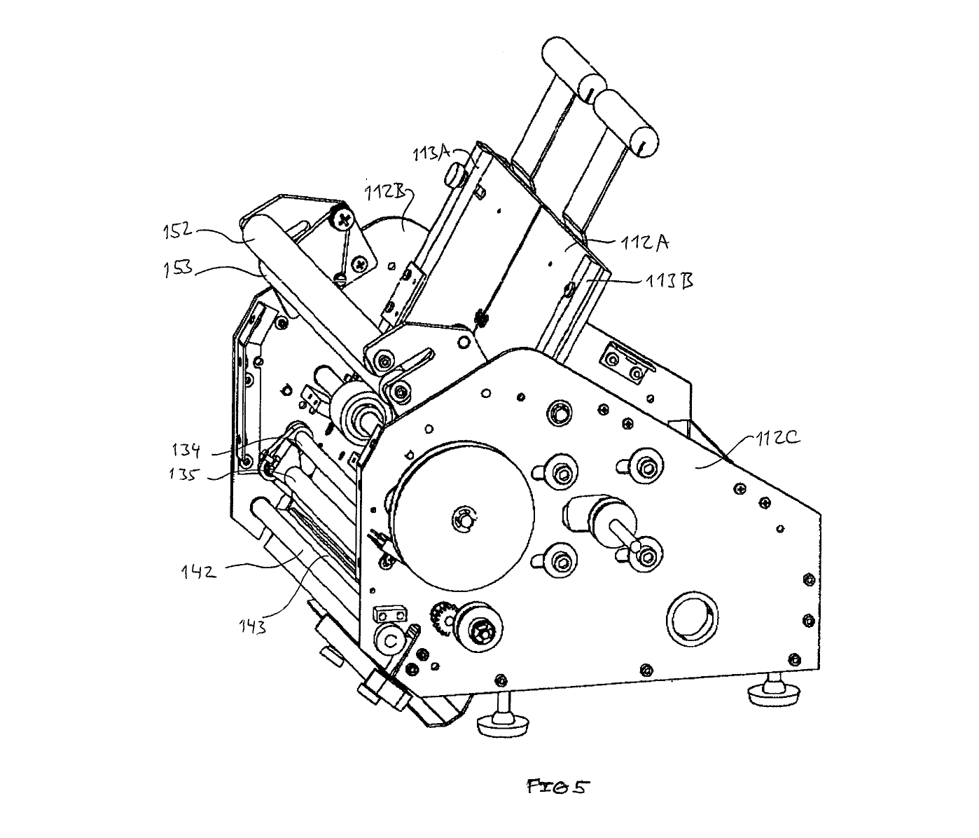

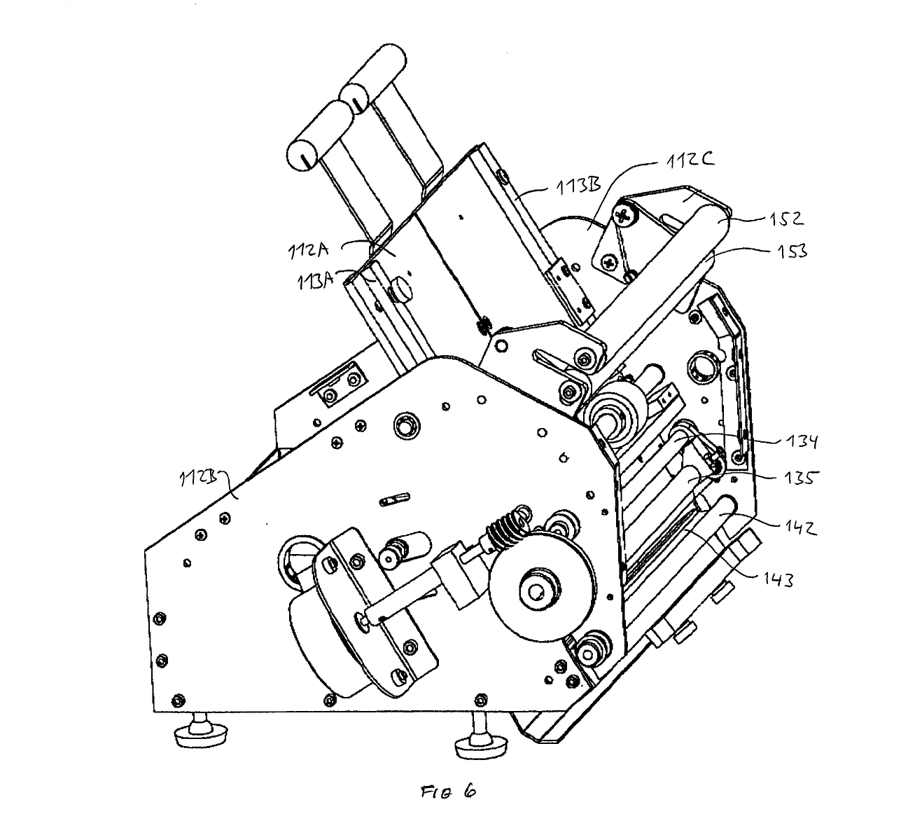

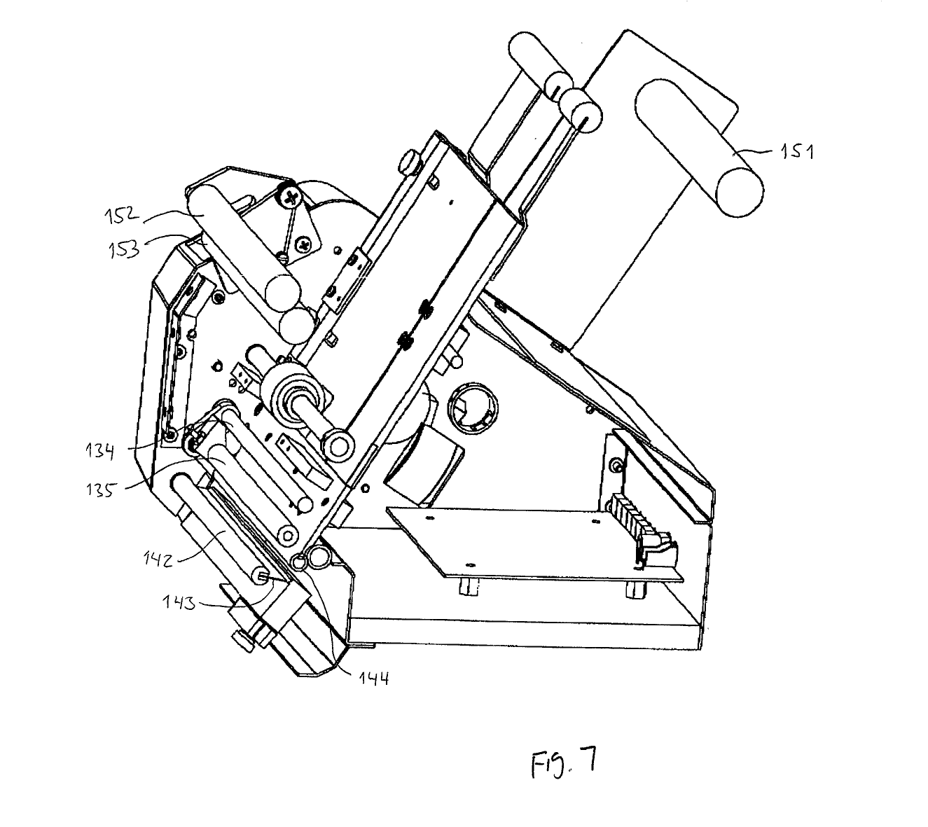

FIGS. 1 & 2 illustrate examples of a label application system according to the present invention, while FIGS. 3-6 illustrate front, top, right side, left side views, respectively, of an example of a label application machine according to the present invention. FIG. 7 illustrates a cross sectional view of an example of a label application machine according to the present invention. The major components of label application system 100 are a label application machine 101, a printing system 102 and computer system 103. The label application machine 101 comprises a peeling assembly, an application assembly, and a load and feed assembly that are controlled by a microprocessor. The computer system 103 and printing system 102 could be a conventional computer system 103 and printing system 102 configured to produce and print the label stock. The microprocessor is of the type commonly known in the art, and provides the hardware base for controlling the label application machine 101. Power is supplied to the label application machine 101 by an external wall transformer also of the type commonly known in the art.

The label application machine 101 is mounted to a frame and partially enclosed by a housing 111A, 111B. The housing 111A, 111B includes plastic covers that detachably mount to the frame so that they may be removed during system maintenance. The frame includes a sloped guide plate 112A connected between opposing sidewalls 112B, 112C, a back wall 112D and a bottom 112E defining an interior cavity that contains some of the components of the label application machine 101. Advantageously, the sidewalls 112B, 112C provide an arcuate upper edge for reducing size, weight, and production cost by eliminating excess material. A pair of adjustable label stock guides 113A,113B are connected to the sloped guide plate 112A to complete the sheet label stock load assembly that receives and positions the label stock for application.

The load and feed assemblies operate to load label stock to an application position and advance label stock as individual labels are applied. The major powered components of the load and feed assembly are a feed motor 131, and rollers 132-135 that operate to move the label stock through the label application machine 101.

A Clutch isolates the duty cycle of the rollers 132-135 during the feeding so that the rollers 132-135 may operate at different speeds. Advantageously, this reduces the overall number of motors required to practice the principles of the present label application machine 101.

The peeling of an individual label from the label stock when the label stock is in the application position is performed by the bending of the label stock backing approximately 45 degrees as the label stock is fed through the label application machine 101. The application assembly includes an application motor 141 and application bar 142. The application bar 142 includes a mylar strip 143 connected and extending substantially the length of application bar 142. The application bar 142 is fixedly mounted for rotation about a horizontal axis between the sidewalls 112B, 112C and is rotated by the application motor 141 to swipe an individual label onto a file folder or other article.

Setup of label application machine 101 includes connecting the appropriate sheet fed between guides 113A, 113B or roll label stock assembly (on bar 151 and fed over rollers 152, 153) to the label application machine 101. The desired label stock is then loaded into the label application machine 101. When the label application machine 101 is activated, the label stock is advanced into the label application machine 101 to an application position as determined by a sensor. During the advancing of the label stock the lead edge is deflected over edge guide 144 to peel an individual label approximately half way off of the backing sheet. The deflection peels the label by deflecting the lead edge of the label backing approximately 90° while allowing the lead edge of the label to proceed axially. The angular direction of the lead edge of the label backing relative to the axial direction of the lead edge of the label peels the label in much the same way as a label is peeled from a label-backing sheet by hand. In the application position the label is peeled approximately half way off the label backing and the system is paused until an article is inserted into the article receiving slot 145.

The article is inserted into the article receiving slot 145 until the lead edge of the article engages a switch and initiates the application of the individual label. Alternatively, the article could be moved horizontally to the right or left following insertion to engage the switch and initiate the application process. Still alternatively, a foot pedal or other means such as a switch on the control panel could initiate the application process. The switch simultaneously initiates the application assembly and the feed assembly. When the application assembly is initiated, the application bar rotates about a horizontal axis swiping the peeled half of the label onto the inserted portion of the article. Substantially, simultaneously the feed operation is initiated to advance the label backing, moving the next sequential label into the application position. The article is then removed from the slot and inserted into a tabbing assembly. The tabbing assembly folds the second half of the label over the file folder producing a labeled folder. The total time for applying a single label to a single article is approximately 8-9 seconds.

Where sheet label stock is utilized, the individual label backing sheets are fed through the label application machine 101 with the next sequential backing sheet dropping into the load position as the prior sheet is advanced. When the end of the label backing sheet is reached, the microprocessor, in response to an optical sensor, simultaneously loads a subsequent sheet of label backing.

Thus, it is apparent that this label application system 101 fully satisfies the objects, aims, and advantages set forth above. While the label application system 101 has been described in conjunction with specific embodiments thereof, it is evident that many alternatives, modifications, and variations can be devised by those skilled in the art in light of the foregoing description. Accordingly, it is intended to embrace all such alternatives, modifications and variations as fall within the spirit and scope of the appended claims.

What is claimed:

1. A label application machine for use in automatically applying at least one label to at least one article, the label application machine comprising:
means for receiving the at least one article for application of the at least one label to the at least one article;
means for receiving label stock containing the at least one label; and
means for automatically applying the at least one label from the label stock to the at least one article at variable locations on the at least one article.

2. The label application machine of claim 1 further comprising:
label stock feeding means for advancing said label stock from a load position to an application position;
means for determining when said label stock is in said application position; and
means, responsive to said determining means, for disengaging said feeding means when said label stock is in said application position.

3. The label application machine of claim 3 further comprising:
driving means, responsive to said application means, for automatically advancing successive label stock to said application position; and
means, responsive to said driving means, for peeling said at least one label from said label stock.

4. The label application machine of claim 3 further comprising:
means, responsive to insertion of said article into said means for receiving, for activating said means for automatically applying.

5. The label application machine of claim 3 wherein said means for automatically applying comprises:
applicator bar means having a wiper strip attached thereto for applying said peeled at least one label to said article; and
motor means, connected to said applicator bar means, for rotating said applicator bar means about a pivot to cause said wiper strip to force said peeled said at least one label on to said article via a wiping action.

6. The label application machine of claim 3 wherein said means for receiving label stock comprises:
a pair of adjustable guides for positioning said label stock with respect to said article.

7. The label application machine of claim 1 further comprising:
means for generating a set of data comprising the at least one label; and
means for producing a tangible form of the generated set of data on at least one label.
